(19) United States
(12) Patent Application Publication
(10) Pub. No.: US 2015/0284072 A1
(43) Pub. Date: Oct. 8, 2015

(54) DRAG REDUCTION THROUGH ION FIELD FLOW CONTROL

(71) Applicant: United Technologies Corporation, Hartford, CT (US)

(72) Inventors: Alan B. Minick, Madison, AL (US); William T. Cousins, Glastonbury, CT (US)

(21) Appl. No.: 14/629,558

(22) Filed: Feb. 24, 2015

Related U.S. Application Data
(62) Division of application No. 13/185,483, filed on Jul. 18, 2011.
Application No. 13/185,483 is a continuation-in-part of application No. 11/960,126, filed on Dec. 19, 2007, now Pat. No. 8,091,836.

(51) Int. Cl. B64C 23/00

(52) U.S. Cl. CPC B64C 23/005

(57) ABSTRACT

A method for controlling a boundary layer over a vehicle surface includes generating an ionic wind using a network of emitters and receivers. An external fluid is propelled with the ionic wind over the vehicle surface. The strength of the ionic wind is controlled to adjust the boundary layer thickness.

### REFERENCE TO RELATED APPLICATIONS

The application is a divisional of U.S. application Ser. No. 13/185,483 filed Jul. 18, 2011 which is a continuation-in-part application to U.S. patent application Ser. No. 11/960,126, filed Dec. 19, 2007, now U.S. Pat. No. 8,091,836 granted Jan. 10, 2012.

### BACKGROUND

The present application relates to boundary layer control using ionic winds.

In aircraft as well as other vehicles, significant energy is expended to compensate for skin friction and boundary layer build up. The energy consumed in the boundary layer increases with the size, speed, and characteristic shape of the vehicle. As boundary layer build up continues, separation of the boundary layer can occur which results in increased drag and low pressure wake separation. This increases power required for propulsion. Additionally, any disturbance or roughness on the vehicle surface can increase the boundary layer or induce separation, again this increases total system drag.

Various types of surface modifications have been attempted to modify boundary layers and for wake filling, including vortex generators, flaps, slots, surface suction, and blowing. Each of these systems requires significant energy to affect the boundary layer and have varying effectiveness across vehicle speed ranges.

### SUMMARY

In one exemplary embodiment, a method for controlling a boundary layer over a vehicle surface includes generating an ionic wind using a network of emitters and receivers. An external fluid is propelled with the ionic wind over the vehicle surface. The strength of the ionic wind is controlled to adjust the boundary layer thickness.

In a further embodiment of the above, the external fluid is propelled in a same direction as a vehicle with the network of emitters and receivers to increase the boundary layer thickness.

In a further embodiment of any of the above, the external fluid is propelled in an opposite direction as a vehicle with the network of emitters and receivers to decrease the boundary layer thickness.

In a further embodiment of any of the above, the network of emitters and receivers are embedded in the vehicle surface.

In a further embodiment of any of the above, the vehicle surface is an aircraft wing. The network of emitters and receivers include a plurality of emitters and a plurality of receivers with all of the plurality of receivers located on only one side of the aircraft wing.

In a further embodiment of any of the above, the network of emitters and receivers include an emitter placed immediately adjacent a receiver.

In a further embodiment of any of the above, the emitter is a wire anode and the receiver is a plate cathode.

In a further embodiment of any of the above, the vehicle surface is an aircraft wing and the ionic wind travels on only one side of the aircraft wing.

In a further embodiment of any of the above, the vehicle surface is an aircraft wing and the network of emitters and receivers is located inward from a leading edge and a trailing edge of the aircraft wing.

In a further embodiment of any of the above, the network of emitters and receivers is powered by at least one of a pulse or a constant DC power source.

In a further embodiment of any of the above, the network of emitters and receivers is powered by an AC power source.

In a further embodiment of any of the above, controlling the ionic wind is at least partially based on an aircraft flight condition.

In a further embodiment of any of the above, the aircraft flight condition includes steering.

In a further embodiment of any of the above, the aircraft flight condition includes deceleration.

In a further embodiment of any of the above, the aircraft flight condition includes a change in lift.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 illustrates an emitter/receiver array on a surface;

FIG. 2 illustrates features of a modified boundary layer;

FIG. 3 illustrates the effect on the boundary layer for various levels of control; and

FIG. 4 illustrates an application to a vehicle surface.

### DETAILED DESCRIPTION OF AN EMBODIMENT

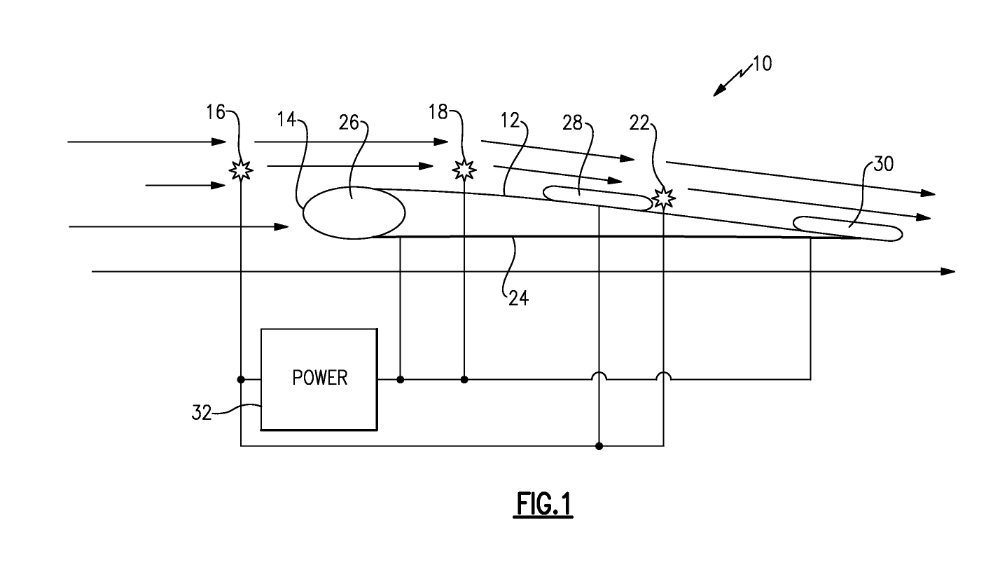

FIG. 1 illustrates a boundary layer control system 10 for a vehicle 12 such as a wing of an aircraft. It should be understood that the vehicle 12 may be a portion of, or the entirety of a conventional or lighter than air aircraft as well as other vehicles such as land vehicles. In this non-limiting embodiment, the vehicle 12 may include a wing with a leading edge 14.

The system 10 generally includes a first emitter 16 on the vehicle 12 itself, or ahead of a surface 14 of the vehicle 12 such as forward of a leading edge 14. The emitter 16 is coupled with a receiver 26 on or near the surface 14. It is additionally possible to install multiple emitter/receiver pairs to provide a network to generate a relatively stronger and larger ionic boundary layer modification. A boundary layer, as defined herein, is a thin layer of fluid immediately next to a solid body that flows more slowly than the rest of the fluid. It should be understood that although boundary layer is described herein as being controlled, since the fluid adjacent the solid body such as the illustrated wing is accelerated faster than the rest of the fluid, that area may understood as not actually being part of the boundary layer as generally understood. In other words, the system 10 reduces the boundary layer and also affects the fluid beyond the boundary layer.

In the disclosed non-limiting embodiment, two additional emitters 18, 22 and two additional receivers 28, 30 are placed on the vehicle 12 to increase boundary layer control. Each emitter and receiver set may each also include a series of emitter and receivers to provide multiple stages of ion wind enhancement at each given location. Also, the charge of the emitter and receiver set may be alternated to enhance stage density and total system effectiveness.

Each emitter 16, 18, 22 operates as an ion source and each of the receivers 26, 28, 30 operates as an ion collector such that the emitter/receiver network may be utilized to create a directed ion field. Each of the emitters 16, 18, 22 and each of the receivers 26, 28, 30 may be manufactured of an electrically conductive material such as, for example only, carbon fiber material or nanotubes. Created ions repelled by the emitters 16, 18, 22 drive the emitters 16, 18, 22 forward and ions aft while the opposite charge on the respective receivers 26, 28, 30 accelerates ion towards (and past) the receivers 26, 28, 30 which accelerates the emitters 16, 18, 22 forward by attraction to the created ions. Such related emitter-attractor sets may be stacked for improved efficiency.

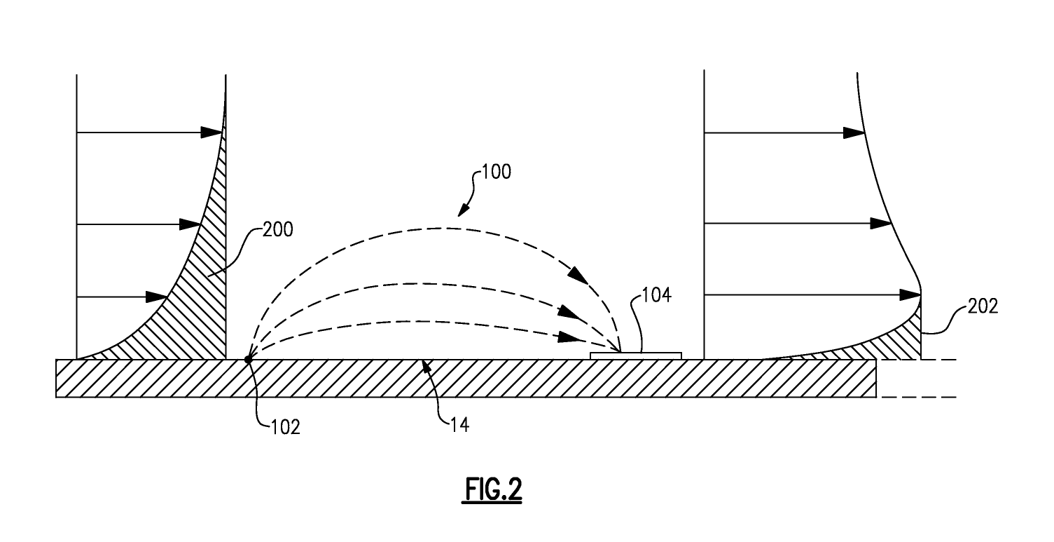

With reference to FIG. 2, the system 10 may be utilized to generate a directed ion field, referred to herein as ionic wind 100. The ionic wind 100 is generated by a current through an anode (or cathode) 102 of each emitter and through a cathode (or anode) 104 of each receiver. The velocity of a fluid traveling in the boundary layer prior to application of the ionic wind 100 is shown on the left side of FIG. 2 in shaded region 200. The shaded region 200 represents the velocity of the fluid relative to the surface 14. Accordingly, the fluid at the top of the shaded region 200 is farther away from the surface 14 than the fluid at the bottom of the shaded region 200. After the ionic wind 100 is applied to the fluid, the altered boundary layer velocity characteristics, which are illustrated in a second shaded region 202, change. The second shaded region 202 illustrates the velocity of the fluid traveling in the boundary layer after influenced by the ionic wind 100. In the illustrated example of FIG. 2, the ionic wind 100 is shown forcing the fluid in a direction in opposition to the direction of motion of the surface 14. This results in a reduced boundary layer thickness as shown in shaded region 202.

Reduction of the boundary layer reduces the parasitic drag and decreasing the likelihood of boundary layer separation which occurs when the boundary layer lifts off the surface of the surface 14 which thereby creates an air gap between the boundary layer and the surface 14. This results in a pressure buildup between the boundary layer and the surface 14. The increase in pressure can result in a decrease in performance, such as decreased lift or increased air flow impact.

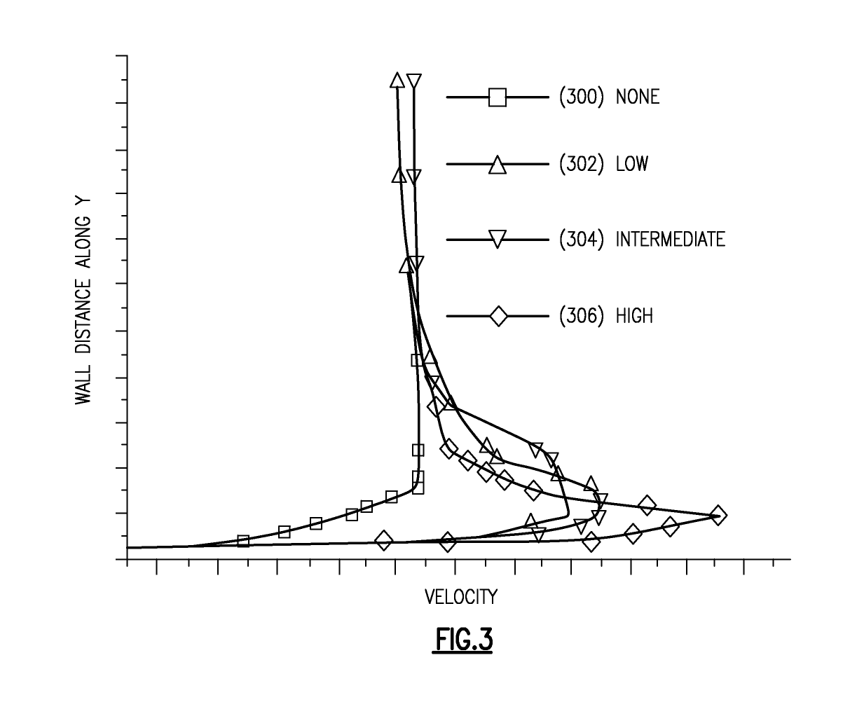

With reference to FIG. 3, the boundary layer thickness may be readily adjusted by the level of control applied to the emitters 16, 18, and 22 and the receivers 26, 28, and 30. FIG. 3 shows the boundary layer characteristics for no control being applied, for a low level of control being applied, for an intermediate level of control being applied, and for a high level of control being applied. As can be seen from the shape of the boundary layer characteristics of the varying levels of control, the higher the level of control applied, the greater the impact on the boundary layer characteristics.

Boundary layer characteristic 300 illustrates the thickness of the boundary layer without the application of any control. The distance from the velocity axis to the curve of the graph is representative of the boundary layer thickness. Boundary layer characteristic 302 illustrates how the thickness is reduced after the application of a minimal boundary layer control. As a larger level of control is applied the thickness decreases, as illustrated with a moderate level of control 304 and a high level of control 306. Varying the level of control is achieved through strength modification of the ionic wind 100. The strength of the ionic wind 100 is determined by the level of current applied across the emitter/receiver network. FIG. 3 illustrates the boundary layer characteristics in an embodiment that forces the fluid in a direction in opposition to the vehicle's motion. Through variation in boundary layer control (including reduced or reversed flow) across various portion of the vehicle various additional effects such as steering, braking, increased lift, and stability can be accomplished in addition to drag reduction.

Using emitters 16, 18, 22 and receivers 26, 28, 30 to generate the ionic wind 100 requires minimal space. The emitter 16, 18, 22 and receiver 26, 28, 30 properties for a given surface are not defined by their proximity to each other, but by physical shape. For example, the emitter 16 may be a wire anode and the receiver 26 may be a plate cathode. This allows the emitter and the receiver to be, for example, placed immediately adjacent to each other yet still retain the desired ionic wind 100 capabilities.

The emitters 16, 18, 22 and the receivers 26, 28, 30 in the illustrated embodiments are powered from a power source 32 (FIG. 1) operable to produce either pulse DC power or constant DC power. Alternatively, or in addition thereto, an alternating current (AC) power source could be used to operate the emitter/receiver network.

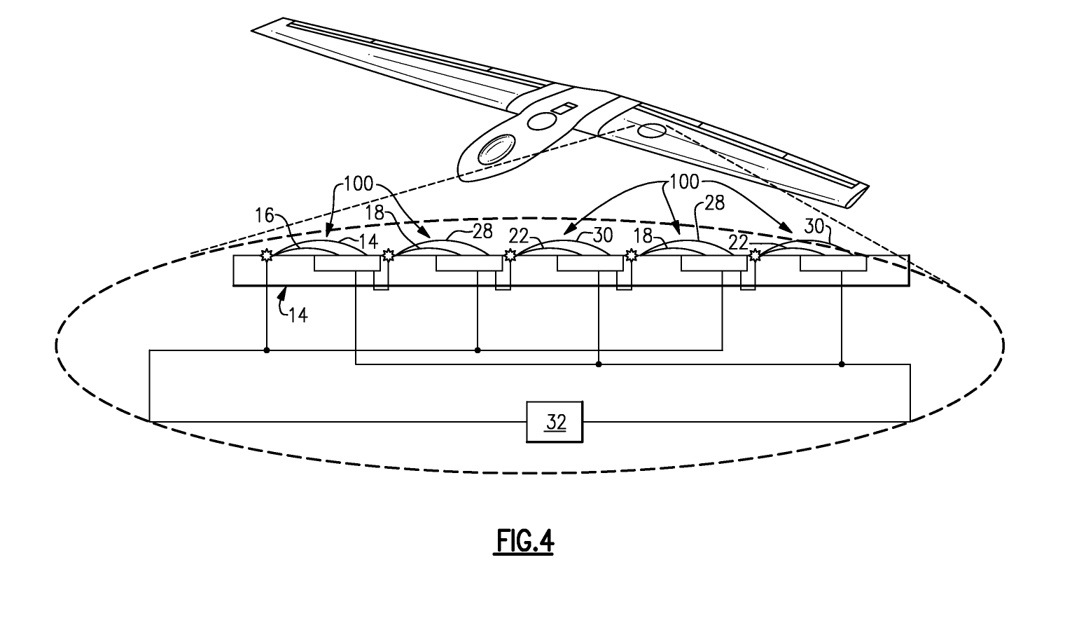

With reference to FIG. 4, the network of emitters 16, 18, 22 and receivers 26, 28, 30 are applied to the surface 14 of an aircraft or other vehicle. In this embodiment, the emitters 16, 18, 22 and the receivers 26, 28, 30 produce the ionic wind 100 adjacent to the surface 14 which is illustrated herein as an aircraft wing. The size of ionic wind 100 illustrated in FIG. 4 is exaggerated for illustrative purposes and is not shown to scale. Boundary layer control adjacent to the surface 14 can allow for the object to experience reduced parasitic drag, reduced separation, and reduced wake drag.

Typically, it is necessary to account for non-optimal airflow conditions, such as varying speed or surface features required for practical vehicles. Implementing boundary layer control on the surface 14, such as is described above, minimizes the impact of adverse conditions and allows for the vehicle to be operated at higher efficiency than is possible without boundary layer control.

It should be understood that relative positional terms such as “forward,” “aft,” “upper,” “lower,” “above,” “below,” and the like are with reference to the normal operational attitude of the vehicle and should not be considered otherwise limiting.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A method for controlling a boundary layer over a vehicle surface comprising:
generating an ionic wind using a network of emitters and receivers;
propelling an external fluid with the ionic wind over the vehicle surface; and
controlling the strength of the ionic wind to adjust said boundary layer thickness.

2. The method as recited in claim 1 further comprising:
propelling the external fluid in a same direction as a vehicle with the network of emitters and receivers to increase the boundary layer thickness.

3. The method as recited in claim 1 further comprising:
propelling the external fluid in an opposite direction as a vehicle with the network of emitters and receivers to decrease the boundary layer thickness.

4. The method of claim 1, wherein the network of emitters and receivers are embedded in the vehicle surface.

5. The method of claim 1, wherein the vehicle surface is an aircraft wing and the network of emitters and receivers include a plurality of emitters and a plurality of receivers with all of the plurality of receivers located on only one side of the aircraft wing.

6. The method of claim 1, wherein the network of emitters and receivers include an emitter placed immediately adjacent a receiver.

7. The method of claim 6, wherein the emitter is a wire anode and the receiver is a plate cathode.

8. The method of claim 1, wherein vehicle surface is an aircraft wing and the ionic wind travels on only one side of the aircraft wing.

9. The method of claim 1, wherein the vehicle surface is an aircraft wing and the network of emitters and receivers is located inward from a leading edge and a trailing edge of the aircraft wing.

10. The method of claim 1, wherein the network of emitters and receivers is powered by at least one of a pulse or a constant DC power source.

11. The method of claim 1, wherein the network of emitters and receivers is powered by an AC power source.

12. The method of claim 1, further comprising controlling said ionic wind at least partially based on an aircraft flight condition.

13. The method of claim 12, wherein said aircraft flight condition includes steering.

14. The method of claim 12, wherein said aircraft flight condition includes deceleration.

15. The method of claim 12, wherein said aircraft flight condition includes a change in lift.
